(19) United States
(12) Patent Application Publication
(10) Pub. No.: US 2009/0068499 A1
(43) Pub. Date: Mar. 12, 2009

(54) MAGNETIC RECORDING MEDIUM, PRODUCTION PROCESS THEREOF, AND MAGNETIC RECORDING AND REPRODUCING APPARATUS

(75) Inventor: Hiroshi Osawa, Chiba-shi (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Minato-ku, Tokyo (JP)

(21) Appl. No.: 11/817,854

(22) PCT Filed: Mar. 3, 2006
(86) PCT No.: PCT/JP2006/304680

§ 371 Date: Sep. 5, 2007

Related U.S. Application Data
(60) Provisional application No. 60/661,901, filed on Mar. 16, 2005.

(30) Foreign Application Priority Data
Mar. 7, 2005 (JP) 2005-062499
Apr. 21, 2005 (JP) 2005-123535

(51) Int. Cl. G11B 5/738; G11B 5/65

(52) U.S. Cl. 428/831

(57) ABSTRACT

There is provided a magnetic recording medium formed on an aluminum substrate (Al—Mg alloy), provided with texture striations and a plated layer of NiP, which has magnetic recording medium has magnetic anisotropy in the circumferential direction, and has a high retentivity, a high squareness ratio, and favorable electromagnetic transfer characteristics, a production method thereof, and a magnetic recording and reproducing apparatus. The magnetic recording medium comprises at least an orientation control layer, a nonmagnetic undercoat layer, a magnetic layer, and a protective layer in this order on the aluminum substrate. The orientation control layer contains any one or more component types selected from among Co, Ni, and Fe, and any one or more component types selected from among W, Mo, Ta and Nb.

### CROSS-REFERENCE TO RELATED APPLICATION

The present application is filed under 35 U.S.C. § 111(a), and claims benefit, pursuant to 35 U.S.C. § 119(e)(1), of the filing dates of Provisional Application No. 60/661,901 filed Mar. 16, 2005, pursuant to 35 U.S.C. § 111(b).

### TECHNICAL FIELD

The present invention relates to a magnetic recording medium used in hard disk devices and the like, a production method of the magnetic recording medium, and a magnetic recording and reproducing apparatus.

### BACKGROUND ART

The recording density of hard disk devices (HDD), which are one type of magnetic recording and reproducing apparatus, is currently increasing at an annual rate of 30%, and it is expected that this trend will continue in the future. Consequently, the development of magnetic recording heads, and the development of magnetic recording mediums suitable for high recording density is being advanced.

There is a need to increase the recording density of magnetic recording mediums used for hard disk devices, together with a demand for an improvement in coercive force, and a reduction in medium noise.

For magnetic recording mediums used for hard disk devices, a structure where a metal film is laminated on a substrate for a magnetic recording medium by the sputtering method is mainstream. Moreover, for a substrate used for a magnetic recording medium, aluminum substrates and glass substrates are widely used.

An example of an aluminum substrate includes a mirror polished Al—Mg alloy with a Ni—P type alloy film formed on the substrate to a thickness of approximately 10 μm by electroless deposition, with a surface thereof which is further mirror finished.

For the glass substrate, there are two types which respectively use amorphous glass or crystallized glass, and for either glass substrate, one which is mirror finished is used.

Conventionally, in magnetic recording mediums generally used in hard disk devices, a nonmagnetic undercoat layer (Ni—Al type alloy, Cr, Cr type alloy or the like), a nonmagnetic middle layer (Co—Cr, Co—Cr—Ta type alloy or the like), a magnetic layer (Co—Cr—Pt—Ta, Co—Cr—Pt—B type alloy or the like), and a protective layer (carbon or the like) are sequentially deposited on a nonmagnetic substrate, whereupon a lubricating layer comprising liquid lubricant is formed.

Furthermore, together with increasing the recording density of magnetic disk devices and the like, there is a need to make the magnetic recording mediums a configuration where the magnetic anisotropy is provided in the circumferential direction, and to make the electromagnetic transfer characteristics favorable. Consequently, for magnetic recording mediums using a substrate where NiP is plated on an aluminum alloy (hereunder, is abbreviated to aluminum substrate), there are mediums with a configuration where the anisotropy is provided in the circumferential direction by mechanically forming grooves in the circumferential direction of the Nip surface (hereunder referred to as “mechanical texture processing”).

Furthermore, in cases where the abovementioned mechanical texture processing was performed on glass substrates, it was difficult to provide the magnetic anisotropy in the circumferential direction to the glass substrate itself. Consequently, a magnetic recording medium which expresses magnetic anisotropy in the circumferential direction as a result of a configuration where an orientation control layer is formed on the glass substrate, which had texture striations applied, has been proposed by the present applicant (for example, Patent Document 1).

[Patent Document 1] Japanese Unexamined Patent Application, First Publication No. 2004-86936.

### DISCLOSURE OF INVENTION

### Problems to be Solved by the Invention

In the magnetic recording medium disclosed in Patent Document 1, since the magnetic anisotropy in the circumferential direction is not expressed in a case where the glass substrate is used as is, the configuration is one expressing the magnetic anisotropy by providing an orientation control layer.

However, in order to fulfill the demand for further improvements in the magnetic anisotropy in order to achieve even higher recording densities in magnetic recording mediums, in a configuration where an orientation control layer is provided on the glass substrate of the magnetic recording medium as disclosed in Patent Document 1, it becomes difficult to express a high magnetic anisotropy, and there is concern that favorable electromagnetic transfer characteristics cannot be obtained.

The present invention takes into account the above-mentioned circumstances, with an object of providing a magnetic recording medium which uses an aluminum substrate (Al—Mg alloy), which has had texture striations provided and has been plated with NiP, possessing magnetic anisotropy in the circumferential direction, and has a high magnetic anisotropy as a result of further providing an orientation control layer, and even in a case where an orientation control layer with a thin film thickness is used, has a high retentivity, a high squareness ratio, and favorable electromagnetic transfer characteristics, a production method thereof, and a magnetic recording and reproducing apparatus.

### Means for Solving the Problem

In order to solve the above problems, the present applicant, as a result of earnest investigation and effort, has completed the present invention by identifying that the characteristics of the magnetic recording and reproducing apparatus can be improved by using an alloy layer configured by any one or more component types selected from among Co, Ni, and Fe, and any one or more component types selected from among W, Mo, Ta and Nb, as an orientation control layer upon an aluminum substrate (Al—Mg alloy) to which texture striations have been applied and Nip has been plated.

That is to say, the present invention relates to the following.

(1) A magnetic recording medium characterized in that the magnetic recording medium comprises at least an orientation control layer, a nonmagnetic undercoat layer, a magnetic layer, and a protective layer in this order on an aluminum substrate which has striations on the surface and is plated with NiP or a NiP alloy, wherein the orientation control layer contains any one or more component types selected from among Co, Ni, and Fe, and any one or more component types selected from among W, Mo, Ta and Nb.

(2) A magnetic recording medium according to (1), wherein the orientation control layer contains at least one alloy selected from the group consisting of a Co—W type alloy, a Co—Mo type alloy, a Co—Ta type alloy, a Co—Nb type alloy, a Ni—Ta type alloy a Ni—Nb type alloy, a Fe—W type alloy, a Fe—Mo type alloy, and a Fe—Nb type alloy.

(3) A magnetic recording medium according to (1) or (2), wherein the aluminum substrate is one where a Ni—P type alloy film is formed by electroless deposition on an Al—Mg alloy substrate body.

(4) A magnetic recording medium according to any one of (1) to (3), wherein a film thickness of the orientation control layer is within a range of 1 angstrom to 50 angstroms.

(5) A magnetic recording medium according to any one of (1) to (4), wherein a line density of the striations is 7500 (lines/mm) or more.

(6) A magnetic recording medium according to any one of (1) to (5), wherein a magnetic anisotropic index of the magnetic layer (retentivity in the circumferential direction/retentivity in the radial direction), is 1.05 or more.

(7) A magnetic recording medium according to any one of (1) to (6), wherein a magnetic anisotropic index of the residual magnetization amount (residual magnetization amount in the circumferential direction/residual magnetization amount in the radial direction), is 1.05 or more.

(8) A magnetic recording medium according to any one of (1) to (7), wherein the nonmagnetic undercoat layer contains a Cr layer, or a Cr alloy layer containing one or more components selected the group consisting of Ti, Mo, Al, Ta, W, Ni, B, Si, V, and Mn.

(9) A magnetic recording medium according to any one of (1) to (8), wherein the magnetic layer contains any one or more components selected from the group consisting of a Co—Cr—Pt type alloy, a Co—Cr—Pt—Ta type alloy, a Co—Cr—Pt—B type alloy, and a Co—Cr—Pt—B—Y type alloy (Y represents Ta or Cu).

(10) A magnetic recording and reproducing apparatus characterized in comprising a magnetic recording medium according to any one of (1) to (9), and a magnetic head which records and reproduces information on the magnetic recording medium.

### EFFECTS OF THE INVENTION

Since the magnetic recording medium of the present invention comprises at least an orientation control layer, a nonmagnetic undercoat layer, a magnetic layer, and a protective layer in this order on an aluminum substrate which has striations on the surface and is plated with NiP or a NiP alloy, wherein the orientation control layer represents a configuration containing any one or more component types selected from among Co, Ni, and Fe, and any one or more component types selected from among W, Mo, Ta and Nb, a high magnetic anisotropy in the circumferential direction can be expressed.

Accordingly, the electromagnetic transfer characteristics improve, and a magnetic recording medium suitable for high recording densities can be obtained.

### BRIEF DESCRIPTION OF THE DRAWINGS

FIG. 1 is an outline cross-sectional view explaining an example of a magnetic recording medium according to the present invention.

FIG. 2 is an outline view explaining a magnetic recording and reproducing apparatus using a magnetic recording medium according to the present invention.

### BRIEF DESCRIPTION OF THE REFERENCE SYMBOLS

1 Magnetic recording medium, 2 Aluminum substrate, 3 Orientation control layer, 4 Nonmagnetic undercoat layer, 5 Magnetic layer, 6 Protective layer, 11 Magnetic recording and reproducing apparatus, 13 Magnetic head.

### BEST MODE FOR CARRYING OUT THE INVENTION

Hereunder, an embodiment of the magnetic recording medium according to the present invention is explained with reference to the drawings.

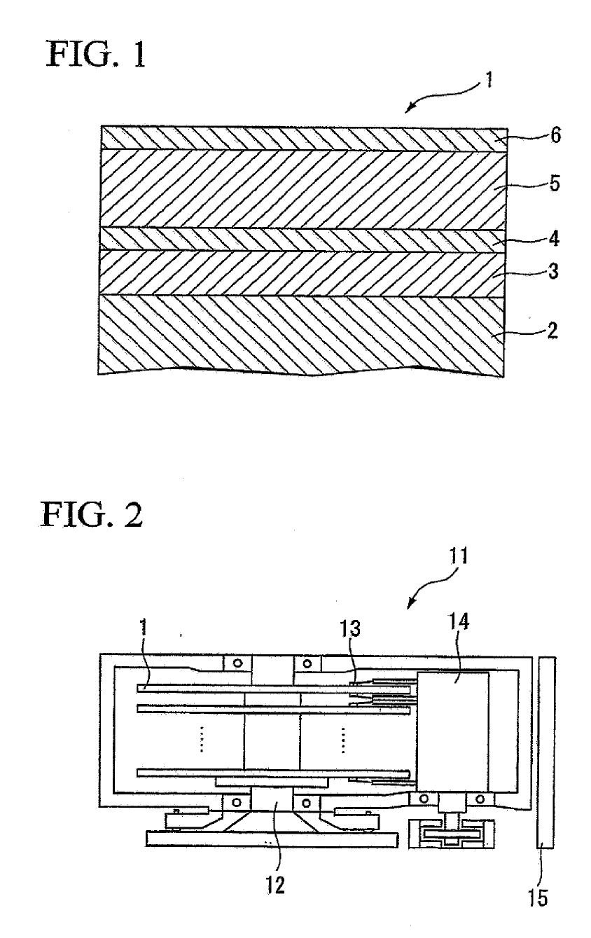

FIG. 1 and FIG. 2 are drawings explaining the magnetic recording medium of the present embodiment. This magnetic recording medium 1 has striations on the surface, and is characterized by comprising at least an orientation control layer, a nonmagnetic undercoat layer, a magnetic layer, and a protective layer in this order on an aluminum substrate which is plated with NiP or a NiP alloy, wherein the orientation control layer contains any one or more component types selected from among Co, Ni, and Fe, and any one or more component types selected from among W, Mo, Ta and Nb.

FIG. 1 is a drawing schematically showing the configuration of the magnetic recording medium 1 of the present embodiment. In FIG. 1, 2 denotes an aluminum substrate, 3 denotes an orientation control layer, 4 denotes a nonmagnetic undercoat layer, 5 denotes a magnetic layer, and 6 denotes a protective layer.

The aluminum substrate 2 represents a Ni—P type alloy film formed to a thickness of approximately 5 to 15 μm by electroless deposition upon a mirror polished Al—Mg alloy substrate, wherein the surface thereof is further mirror polished.

Striations are formed on the surface of the aluminum substrate 2 by, for example, mechanical texture processing by separated abrasive grains or a wrapping tape using fixed abrasive grains. It is preferable for the striations formed on the aluminum substrate 2 surface to run along the substrate circumferential direction.

It is desirable for the surface average roughness Ra of the aluminum substrate 2, to which striations have been formed on the surface, to be made within a range of 0.1 nm to 1 nm (1 angstrom to 10 angstroms), and preferably 0.2 nm to 0.8 nm (2 angstroms to 8 angstroms).

If the surface average roughness Ra of the aluminum substrate 2 is less than 0.1 nm, the aluminum substrate 2 becomes excessively smooth, and the effect of increasing the magnetic anisotropy of the magnetic layer 4 becomes weakened. Furthermore, if the surface average roughness Ra exceeds 1 nm, the smoothness of the medium surface becomes low and the glide height characteristic decreases, making it difficult to lower the flying height of the magnetic head at the time of recording and reproducing.

It is preferable for the surface of the aluminum substrate 2 to have striations at a line density of 7500 (lines/mm) or more. The line density explained here is one which is measured in the radial direction of the aluminum substrate 2.

The reason for making the line density 7500 (lines/mm) or more is that the effects of the striations are reflected by the magnetic properties (for example an effect in improving the retentivity), and the electromagnetic transfer characteristics (for example effects in improving the SNR (signal to noise ratio) and the PW50). More preferably, if it has striations at a line density of 20000 (lines/mm) or more, the abovementioned effects become more prominent.

The upper limit of the line density is 200000 (lines/mm). If the line density exceeds 200000 (lines/mm), the line spacing of the striations becomes less than 50 angstroms, making the particle size of the nonmagnetic undercoat layer larger than the line spacing, thereby lowering the magnetic anisotropy of the magnetic recording medium.

It is preferable for the striations to be formed primarily in the circumferential direction with respect to the aluminum substrate 2. Here, striations refer to uneven shape of the aluminum substrate 2 surface, wherein the vertical distance between the peaks and troughs in a cross section in the radial direction is within a range of 0.02 nm to 20 nm (more preferably within a range of 0.05 nm to 10 nm).

If the vertical distance between the peaks and troughs of the striations is made to be the abovementioned range, it becomes effective with respect to improving the electromagnetic transfer characteristics associated with the expression of the magnetic anisotropy.

In a case where the vertical distance between the peaks and troughs of the striations exceeds 20 nm, the concave and convex shapes of the aluminum substrate 2 surface are too large, and there is a danger of influencing the uniformity of the adjacent striations.

It is preferable for the striations to be formed by, for example, mechanical texture processing by separated abrasive grains or a wrapping tape using fixed abrasive grains.

At the time of measuring the line density of the striations, for example, an AFM (Atomic Force Microscope, manufactured by Digital Instrument Co. (United States)) can be used as a measurement device.

The measurement conditions for line density are made to be as follows.

The scan width is 1 μm, the scan rate is 1 Hz, the number of measurements is 256, and the mode is tapping mode. A probe is scanned in the radial direction of the aluminum substrate, which represents the sample, to obtain the scan image of the AFM. The flatten order degree is made to be 2, and smoothing corrections on the image are performed by executing the plane fit auto process, which represents a smoothing process, to the X axis and Y axis with respect to the scan image. An approximately 0.5 μm×0.5 μm box is set with respect to the smoothing corrected image, and the line density in the area thereof is calculated. The line density is calculated by converting the total number of zero crossover points along both the X axis central line and the Y axis central line to the number per 1 mm. That is to say, the line density becomes the number of peaks and troughs of the texture striations per 1 mm in the radial direction.

Each area within the surface of the aluminum substrate is measured, and the average value and the standard deviation of the measured values thereof are calculated. The number of measurement areas can be made to be a number wherein the average value and standard deviation can be calculated. For example, if the number of measurements is made to be approximately 10 points, it becomes possible to determine the abovementioned average value and standard deviation. Furthermore, by calculating the average value and the standard deviation from 8 points, where the maximum value and the minimum value have been excluded from the original 10 points, abnormal measurement values can be excluded and the measurement accuracy can be improved.

The orientation control layer 3 has a role to adjust the crystalline orientation of the nonmagnetic undercoat layer 4 which is formed directly above, and further adjusts the crystalline orientation of the magnetic layer 5 which is formed thereon, and is a layer for improving the magnetic anisotropy in the circumferential direction of the magnetic layer 5. Furthermore, the orientation control layer 3 not only adjusts the crystalline orientation, but also functions as a crystal grain refining layer which refines crystal grains within the nonmagnetic undercoat layer 4 and the magnetic layer 5.

For the orientation control layer 3, it is possible to use an alloy layer configured by any one or more component types selected from among Co, Ni, and Fe, and any one or more component types selected from among W, Mo, Ta and Nb.

There are no particular restrictions on the alloy layer composition used for the orientation control layer 3, but it is preferable for the total content of Co, Ni, and Fe to be within a range of 25 at % to 70 at %, and the total content of W, Mo, Ta, and Nb to be within a range of 30 at % to 75 at %.

In a case where the total content of Co, Ni, and Fe is less than 25 at %, the crystalline orientation of the nonmagnetic undercoat layer 4 does not become sufficient, thereby lowering the retentivity. If the total content of Co, Ni, and Fe exceeds 70 at %, it is not preferable since the orientation control layer 3 possesses magnetization.

In a case where the total content of W, Mo, Ta, and Nb is less than 30 at %, the magnetic anisotropy in the circumferential direction of the magnetic layer 5 decreases. If the total content of W, Mo, Ta, and Nb exceeds 75 at %, the crystalline orientation of the nonmagnetic undercoat layer 4 does not become sufficient, thereby lowering the retentivity.

For the abovementioned orientation control layer 3, more preferably it is desirable to use at least one alloy layer selected from the group consisting of a Co—W type alloy, a Co—Mo type alloy, a Co—Ta type alloy, a Co—Nb type alloy, a Ni—Ta type alloy, a Ni—Nb type alloy, a Fe—W type alloy, a Fe—Mo type alloy, and a Fe—Nb type alloy. As a result of earnest effort by the present applicant, it has been identified that using an alloy containing a Fe₇W₆ structure further improves the magnetic anisotropy in the circumferential direction of the magnetic layer. As a composition range of these alloy layers, a Fe₇W₆ structure content of at least 25% has an effect from the point of further improving the magnetic anisotropy in the circumferential direction of the magnetic layer 5. That is to say, it is preferable for the composition range of W in a CoW type alloy to be within the range of 30 at % to 85 at %. It is preferable for the composition range of Mo in a CoMo type alloy to be within the range of 30 at % to 85 at %. It is preferable for the composition range of Ta in a CoTa type alloy to be within the range of 38 at % to 65 at %. It is preferable for the composition range of Nb in a CoNb type alloy to be within the range of 37 at % to 86 at %. It is preferable for the composition range of Ta in a NiTa type alloy to be within the range of 38 at % to 63 at %. It is preferable for the composition range of Nb in a NiNb type alloy to be within the range of 31 at % to 86 at %. It is preferable for the composition range of W in a Fe—W type alloy to be within the range of 37 at % to 86 at %. It is preferable for the composition range of Mo in a Fe—Mo type alloy to be within the range of 35 at % to 85 at %. It is preferable for the composition range of Nb in a Fe—Nb type alloy to be within the range of 40 at % to 86 at %.

The Co—W type alloy, the Co—Mo type alloy, the Co—Ta type alloy, the Co—Nb type alloy, the Ni—Ta type alloy, the Ni—Nb type alloy, the Fe—W type alloy, the Fe—Mo type alloy, and the Fe—Nb type alloy, are able to exhibit their characteristics in cases where they are each used individually, and furthermore, the same characteristics are expressed even if the alloy is a combination of a plurality amongst these. For example, the same characteristics are expressed in a Co—W—Mo type alloy, a Co—Ni—Nb type alloy, a Co—W—Mo—Ta type alloy, and the like.

It is preferable for the film thickness of the orientation control layer 3 used in the magnetic recording medium 1 of the present embodiment to be within a range of 1 angstrom to 50 angstroms.

In a case where the film thickness of the orientation control layer 3 is less than 1 angstrom, the crystalline orientation of the nonmagnetic undercoat layer 4 does not become sufficient, thereby lowering the retentivity. If the film thickness of the orientation control layer 3 exceeds 50 angstroms, the magnetic anisotropy in the circumferential direction of the magnetic layer 5 decreases.

Furthermore, it is more preferable from the point of improving the magnetic anisotropy in the circumferential direction of the magnetic layer 5, for the film thickness of the orientation control layer 3 to be within a range of 5 angstroms to 20 angstroms.

In a case where the orientation control layer is applied with respect to a glass substrate, it is optimal for the film thickness of the orientation control layer to be 20 angstroms to 100 angstroms. However in a case where the orientation control layer is applied with respect to an aluminum substrate, 5 angstroms to 20 angstroms is optimal. This is a large difference between a glass substrate and an aluminum substrate at the time of applying the orientation control layer with respect to a substrate.

An element which possesses an auxiliary effect may be added to the orientation control layer 3 explained in the present embodiment.

Examples of an additional element include Ti, V, Cr, Mn, Zr, Hf, Ru, B, Al, Si, P, and the like.

It is preferable for the total content of the additional element to be 20 at % or less. If the total content exceeds 20 at %, the effect of the abovementioned orientation control layer decreases. The lower limit of the lower content is 0.1 at %, and at a content of 0.1 at % or less, the effect of the additional element is lost.

For the nonmagnetic undercoat layer 4, it is preferable to use a Cr layer or a Cr alloy layer comprising Cr and one type or two or more types selected from within Ti, Mo, Al, Ta, W, Ni, B, Si, V, and Mn.

The nonmagnetic undercoat layer 4 can be configured by one layer, although it is preferable for it to be configured by two or more layers.

It is preferable from the point of improving the magnetic anisotropy in the circumferential direction for the Cr layer 41, which is the first layer used directly above the orientation control layer 3, to use Cr, a CrMn type alloy, or a CrFe type alloy.

For the Cr layer 42 used as the second layer, because the lattice constant of Cr alone is small, it is preferable from the point of improving the SNR characteristics of the magnetic recording medium to expand the lattice constant of Cr by adding Mo, W, V, Ti, and the like, such as in a Cr—Mo, Cr—W, Cr—V, or Cr—Ti type alloy, and match the lattice constants of the magnetic layer 5 and the Co alloy. Furthermore, if B is added to the abovementioned Cr layer or Cr alloy layer, there is an effect in grain refinement, which is preferable from the point of improving the SNR characteristics of the magnetic recording medium.

It is preferable for the crystal orientation of the Cr layer or the Cr alloy layer of the nonmagnetic undercoat layer 4 to be made to have a preferred orientation plane in the (100) plane. As a result, the crystal orientation of the Co alloy of the magnetic layer 5, which is formed on the nonmagnetic undercoat layer 4, more strongly exhibits the (11•0), and effects which improve the magnetic characteristics, for example the retentivity (Hc), are obtained, and furthermore, effects which improve the recording and reproducing characteristics, for example the SNR, are obtained.

The “•” within the abovementioned crystal plane notation denotes an abbreviation of a Miller-Bravais index expressing the crystal plane. That is to say, when expressing the crystal plane in a hexagonal system such as Co, it is normally expressed by the four indices (hkil). However, with regard to the “i” within this expression, it is defined as i=−(h+k), and in a format in which this “i” part is abbreviated, the crystal plane is expressed as (hk•l).

It is preferable for the magnetic layer 5 to be a Co alloy, with Co as the principal ingredient, which has a sufficiently good lattice matching with, for example, the (100) plane of the nonmagnetic undercoat layer 4 directly below, and to be made a material which represents a hcp structure. It is preferable for the material to be made to contain any one type selected from, for example, a Co—Cr—Ta type, Co—Cr—Pt type, Co—Cr—Pt—Ta type, Co—Cr—Pt—B—Ta type, Co—Cr—Pt—B—Cu type, or Co—Cr—Pt—B—Ag type alloy.

For example, in the case of the Co—Cr—Pt alloy, it is preferable from the point of improving the SNR, for the content of Cr to be made within a range of 10 at % to 27 at %, and the content of Pt to be made within a range of 8 at % to 16 at %.

Furthermore, for example, in the case of the Co—Cr—Pt—B alloy, it is preferable from the point of improving the SNR, for the content of Cr to be made within a range of 10 at % to 27 at %, the content of Pt to be made within a range of 8 at % to 16 at %, and the content of B to be made within a range of 1 at % to 20 at %.

Moreover, for example, in the case of the Co—Cr—Pt—B—Ta alloy, it is preferable from the point of improving the SNR, for the content of Cr to be made within a range of 10 at % to 27 at %, the content of Pt to be made within a range of 8 at % to 16 at %, the content of B to be made within a range of 1 at % to 20 at %, and the content of Ta to be made within a range of 1 at % to 4 at %.

Furthermore, for example, in the case of the Co—Cr—Pt—B—Cu alloy, it is preferable from the point of improving the SNR, for the content of Cr to be made within a range of 10 at % to 27 at %, the content of Pt to be made within a range of 8 at % to 16 at %, the content of B to be made within a range of 2 at % to 20 at %, and the content of Cu to be made within a range of 1 at % to 10 at %.

Moreover, for example, in the case of the Co—Cr—Pt—B—Ag alloy, it is preferable from the point of improving the SNR, to restrict the content of Cr to be within a range of 10 at % to 27 at %, the content of Pt to be within a range of 8 at % to 16 at %, the content of B to be within a range of 2 at % to 20 at %, and the content of Cu to be within a range of 1 at % to 10 at %.

There are no problems from the viewpoint of thermal fluctuation if the film thickness of the magnetic layer 5 is 10 nm or more, although from the demands towards high recording density, a film thickness of 40 nm or less is preferable. If 40 nm is exceeded, the crystal particle size increases, and favorable recording and reproducing characteristics cannot be obtained.

The magnetic layer 5 may be made to be a multi-layered structure, and the material thereof can be made to be a combination using any selection from within the abovementioned materials.

In a case where the magnetic layer 5 is made to be a multi-layered structure, from the point of improving the SNR characteristics of the recording and reproducing characteristics, it is preferable for the material directly above the nonmagnetic middle layer to comprise a Co—Cr—Pt—B—Ta type alloy, or a Co—Cr—Pt—B—Cu type alloy, or a Co—Cr—Pt—B type alloy. From the point of improving the SNR characteristics of the recording and reproducing characteristics, it is preferable for the uppermost layer to be one comprising a Co—Cr—Pt—B—Cu type alloy, or a Co—Cr—Pt—B type alloy.

In order to promote the epitaxial growth of the Co alloy, it is preferable to provide a nonmagnetic middle layer between the nonmagnetic undercoat layer 4 and the magnetic layer 5. As a result, improvements in the magnetic characteristics, for example, in the retentivity, can be obtained, and furthermore, improvements in the recording and reproducing characteristics, for example in the SNR, can be obtained. The nonmagnetic middle layer can be made to be one containing Co and Cr. As a Co—Cr type alloy, it is preferable for it to be made one containing one type selected from within a Co—Cr type alloy, a Co—Cr—Zr type alloy, a Co—Cr—Zr—Ru type alloy, a Co—Cr—Ta type alloy, and the like.

For example, in the case of the Co—Cr type alloy, it is preferable from the point of improving the SNR, for the content of Cr to be made within a range of 25 at % to 40 at %.

Furthermore, for example, in the case of the Co—Cr—Zr type alloy, it is preferable from the point of improving the SNR, for the content of Cr to be made within a range of 15 at % to 30 at %, and the content of Zr to be made within a range of 2 at % to 10 at %.

Moreover, for example, in the case of the Co—Cr—Zr—Ru type alloy, it is preferable from the point of improving the SNR, for the content of Cr to be made within a range of 15 at % to 30 at %, the content of Zr to be made within a range of 2 at % to 10 at %, and the content of Ru to be made within a range of 2 at % to 10 at %.

Furthermore, for example, in the case of the Co—Cr—Ta type alloy, it is preferable from the point of improving the SNR, for the content of Cr to be made within a range of 15 at % to 30 at %, and the content of Ta to be made within a range of 1 at % to 10 at %.

It is preferable from the point of improving the SNR, for the film thickness of the nonmagnetic middle layer to be within a range of 0.5 nm to 3 nm.

In order to improve the thermal demagnetization of the magnetic recording medium, an antiferromagnetic bonding layer omitted from the drawings can also be provided between the nonmagnetic undercoat layer 4 and the magnetic layer 5. In a magnetic recording medium using this technology, because the section participating in magnetic record reproduction essentially becomes thinner than the thickness of the whole recording film as a result of magnetization directions of the aforementioned two magnetic layers 4 and 5 become mutually reversed, it is possible to achieve an improvement in the SNR. On the other hand, it is possible to improve the thermal instability, due to the enlargement of the volume of crystal grains of the whole recording layer.

A medium utilizing this technology is generally called an AFC medium (Antiferromagnetically-Coupled Media), or an SFM (Synthetic Ferrimagnetic Media). Here, they will be called AFC mediums.

The antiferromagnetic bonding layer is formed from a stabilization layer and a nonmagnetic bonding layer. It is preferable for the stabilization layer to be made a magnetic material containing any one type selected from within a Co—Ru type alloy, a Co—Cr type alloy, a Co—Cr—Zr type alloy, a Co—Cr—Zr—Ru type alloy, a Co—Cr—Ta type alloy, and the like.

For example, in the case of the Co—Ru type alloy, it is preferable from the point of improving the SNR, for the content of Ru to be made within a range of 15 at % to 25 at %.

For example, in the case of the Co—Cr type alloy, it is preferable from the point of improving the SNR, for the content of Cr to be made within a range of 15 at % to 25 at %.

For example, in the case of the Co—Cr—Zr type alloy, it is preferable from the point of improving the SNR, for the content of Cr to be made within a range of 15 at % to 25 at %, and the content of Zr to be made within a range of 2 at % to 10 at %.

For example, in the case of the Co—Cr—Zr—Ru type alloy, it is preferable from the point of improving the SNR, for the content of Cr to be made within a range of 15 at % to 20 at %, the content of Zr to be made within a range of 2 at % to 10 at %, and the content of Ru to be made within a range of 2 at % to 10 at %.

For example, in the case of the Co—Cr—Ta type alloy, it is preferable from the point of improving the SNR, for the content of Cr to be made within a range of 15 at % to 20 at %, and the content of Ta to be made within a range of 1 at % to 10 at %.

It is preferable for the nonmagnetic bonding layer to comprise any one type selected from within Ru, Rh, Ir, Cr, Re, a Ru type alloy, a Rh type alloy, an Ir type alloy, a Cr type alloy, or a Re type alloy.

These materials have large exchange energy constants, and therefore, as a result of their use as the nonmagnetic bonding layer, the degree of inversion of magnetization of the magnetic layers provided above and below this layer can be made to be large.

In particular, because the exchange energy constant of Ru is the largest amongst the abovementioned materials, it is most preferable to use Ru for the nonmagnetic bonding layer.

The exchange energy constant is a value which represents the strength of the exchange interaction of the magnetic layers provided above and below, and the larger the value thereof, the better.

It is preferable for the thickness of the nonmagnetic bonding layer to be made within a range of 0.5 to 1.5 nm (more preferably 0.6 nm to 1.0 nm). By making the thickness of the nonmagnetic bonding layer within the abovementioned range, sufficient antiferromagnetic bonding can be obtained.

For the protective layer 6, a conventionally known material, for example, a simple substance of carbon or SiC, or materials using those as principal components, can be used. It is preferable for the thickness of the protective layer 6 to be made within a range of 0.1 nm to 10 nm from the point of decreasing the magnetic spacing and the durability, in a case where it is used in a high recording density state.

The magnetic spacing represents the distance between the read-write element of the head and the magnetic layer. As the magnetic spacing becomes narrower, the electromagnetic transfer characteristics improve. Because the protective layer 6 exists between the read-write element of the head and the magnetic layer, it becomes a factor in widening the magnetic spacing.

A lubricating layer comprising, for example, a perfluoropolyether fluorine-type lubricant, may be provided on the protective layer 6 if necessary.

It is preferable for the magnetic layer 4 of the magnetic recording medium of the present embodiment to have a magnetic anisotropic index (OR) of 1.05 or more (more preferably 1.1 or more). The magnetic anisotropic index is expressed by (retentivity in the circumferential direction/retentivity in the radial direction). If the magnetic anisotropic index is 1.05 or more, an improvement in the magnetic characteristics, for example retentivity, and an improvement in the electromagnetic transfer characteristics, for example SNR, PW50, can be obtained. The magnetic anisotropic index is defined as the ratio between the retentivity (Hc) in the circumferential direction and the Hc in the radial direction. However because the retentivity of the magnetic recording medium has become high, there are cases where the magnetic anisotropic index is measured to be slightly low.

In the magnetic recording medium 1, to supplement this point, the magnetic anisotropic index of the residual magnetization amount is used together. The magnetic anisotropic index (MrtOR) of the residual magnetization amount is defined as the ratio (MrtOR=Mrt in the circumferential direction/Mrt in the radial direction) between the residual magnetization amount in the circumferential direction (Mrt) and the residual magnetization amount in the radial direction (Mrt). If the magnetic anisotropic index of the residual magnetization amount is 1.05 or more, and more preferably 1.1 or more, superior magnetic characteristics, for example an improvement in the retentivity can be obtained, and superior electromagnetic transfer characteristics, for example improvements in the SNR and the PW50, can be obtained.

The upper limit of the value of OR and MrtOr is ideally a situation where all of the magnetic domains of the magnetic film are directed in the circumferential direction, and in this situation the denominator of the magnetic anisotropic index becomes zero, so that it becomes infinite.

For the measurement of the magnetic anisotropic index and magnetic anisotropic index of the residual magnetization amount, a VSM (Vibrating Sample Magnetometer) is used.

FIG. 2 represents an example of a magnetic recording and reproducing apparatus 11 using the magnetic recording medium 1 of the present embodiment.

This magnetic recording and reproducing apparatus 11 comprises a magnetic recording medium 1 with a configuration shown in FIG. 1, a medium drive unit 12 that rotates the magnetic recording medium 1, a magnetic head 13 that records and reproduces the information in the magnetic recording medium 1, a head drive unit 14 that relatively moves this magnetic head 13 with respect to the magnetic recording medium 1, and a record reproduction signal processing system 15.

The record reproduction signal processing system 15 is able to process the data input from the outside and send the record signal to the magnetic head 13, and process the reproduction signal from the magnetic head 13 and send the data to the outside. For the magnetic head 13 used in the magnetic recording and reproducing apparatus 11, not only an MR (magnetoresistance) element utilizing a gigantic magnetoresistance effect (GMR) as the reproduction element, but a head more suitable for high recording density which has a GMR element using a tunnel magnetoresistance (TMR) effect, and the like, may be used.

Furthermore, because the magnetic recording and reproducing apparatus 11 uses a magnetic recording medium 1 produced by performing texture processing directly on the aluminum substrate 2, it is inexpensive, and achieves a high recording density.

Moreover, because the magnetic recording and reproducing apparatus 11 uses a magnetic recording medium 1 which has a small average roughness and small micro-waviness, in addition to improved electromagnetic transfer characteristics, it has a feature of good error characteristics even when the magnetic head is used at a low floating height in order to decrease spacing loss.

By using the magnetic recording medium 1 of the present embodiment, it becomes possible to manufacture a magnetic recording medium suitable for high recording density.

Hereunder, one example of a manufacturing method of the magnetic recording medium according to the present invention is explained.

As the aluminum substrate 2, it is preferable to use an Al—Mg alloy, to which NiP or an NiP type alloy has been formed by electroless deposition to a thickness of 10 μm thereon.

It is preferable for the surface average roughness Ra of the aluminum substrate 2 to be 2 nm (20 angstroms) or less, and more preferably to be 1 nm or less.

Furthermore, it is preferable for the micro-waviness (Wa) of the surface to be 0.3 nm or less (more preferably 0.25 nm or less). Furthermore, for the flight stability of the magnetic head, it is preferable to make the surface average roughness Ra of at least one of the end face or the side face of the chamfer section to be 10 nm or less (more preferably 9.5 nm or less). The micro-waviness (Wa) can, for example, be measured as a surface average roughness at a measuring range of 80 μm, by utilizing a surface roughness measuring apparatus P-12 (manufactured by KLM-Tencor Co.).

Firstly, texture processing is applied to the surface of the aluminum substrate 2, such that texture striations are formed to a line density of 7500 (lines/mm) or more on the surface of the substrate. For example, a texture is applied in the circumferential direction by machine processing (also known as “mechanical texture processing”) using a fixed abrasive grain and/or a free abrasive grain to form texture striations to a line density of 7500 (lines/mm) or more on the surface of the aluminum substrate 2.

For example, a grinding tape is pressed into contact with the surface of the substrate, and a grinding slurry containing the grinding abrasive grain is supplied between the substrate and the grinding tape, and texture processing is performed by both the rotation of the substrate and the feeding of the grinding tape. The rotation of the substrate may be within a range of 200 rpm to 1000 rpm. The feed rate of the grinding slurry may be made within a range of 10 mL/min to 100 mL/min. The grinding tape feed speed may be made within a range of 1.5 mm/min to 150 mm/min. The grain size of the abrasive grain contained in the abrasive slurry may be made within a 0.05 μm to 0.3 μm at D90 (the grain size value when the cumulative mass % corresponds to 90 mass %). The pressing force of the tape may be made within a range of 1 kgf to 15 kgf (9.8 N to 147 N). These conditions may be appropriately selected such that texture striations are formed at a line density of 7500 (lines/mm) or more, and more preferably no less than 20000 (lines/mm).

It is preferable for the surface average roughness Ra of the aluminum substrate 2 with texture striations formed on its surface to be made within a range of 0.1 nm to 1 nm (1 angstrom to 10 angstroms), and more preferably to be made within a range of 0.2 nm to 0.8 nm (2 angstroms to 8 angstroms).

Furthermore, it is also possible to apply texture processing with additional oscillation on the aluminum substrate 2.

Oscillation is an operation where at the same time as the tape being put in motion in the circumferential direction of the aluminum substrate 2, the tape is swung in the radial direction of the substrate. It is preferable for the oscillation condition to be 60 times/min to 1200 times/min.

As a method of texture processing, a method where texture striations are formed to a line density of 7500 (lines/mm) or more may be used, and other than the abovementioned method by mechanical texturing, a method using a fixed abrasive grain, a method using a fixed whetstone, and a method using laser processing, can be used.

The sputtering conditions for forming the films are, for example, as follows.

At the point of forming the films, the chamber interior is evacuated such that the vacuum falls within a range of 10⁻⁴ Pa to 10⁻⁷ Pa. Sputter deposition is performed by accommodating an aluminum substrate 2 with texture striations formed on its surface in the chamber interior, and discharging electricity by introducing an Ar gas as a sputter gas. At this time, the supplied power is made to be in the range of 0.2 kW to 2.0 kW, and by adjusting the discharge time and supplied power, the desired film thickness can be obtained.

Between the orientation control layer 3 and the nonmagnetic undercoat layer 4, it is preferable to have a process which exposes the surfaces thereof to an oxygen atmosphere. It is preferable for the oxygen atmosphere for exposure to be, for example, an atmosphere containing 5×10⁻⁴ Pa or more of oxygen gas. Furthermore, an atmosphere gas for exposure which has been brought into contact with water may be used. Moreover, it is preferable for the exposure time to be made within a range of 0.5 seconds to 15 seconds.

Furthermore, it is preferable, for example, following the formation of the orientation control layer 3, to remove it from the chamber interior, and expose it to an open air environment or an oxygen environment. Alternatively, it is also preferable to use a method of exposure where it is not removed from the chamber interior, and air or oxygen is introduced into the chamber interior. In particular, since the method of exposure in the chamber interior makes complex processes where it is removed from the vacuum chamber unnecessary, and it can be continuously processed in the chamber interior as a series of film formation processes, including the film formation of the nonmagnetic undercoat layer and the magnetic layer, then this is preferable. In this case, it is preferable, for example, to make the atmosphere one containing 5×10⁻⁴ Pa or more of oxygen gas in a final vacuum of 10⁻⁶ Pa or more. As an upper limit of the oxygen gas pressure at the time of exposure by oxygen, although exposure at atmospheric pressure is possible, it is preferable to make it 5×10⁻² Pa or less.

The crystal orientation of the nonmagnetic undercoat layer 4 and the magnetic layer 5 can be improved by heating the aluminum substrate 2. It is preferable for the heating temperature of the aluminum substrate 2 to be within a range of 100° C. to 300° C. Furthermore, it is preferable to heat the orientation control layer 3 following film formation.

Following formation of the nonmagnetic backing layer 4, a magnetic layer possessing a film thickness of 15 nm to 40 nm is formed by the sputtering method as mentioned above, using a sputtering target comprising a magnetic material. At this point, a material containing any one type selected from the group consisting of a Co—Cr—Ta, a Co—Cr—Pt, a Co—Cr—Pt—Ta, a Co—Cr—Pt—B—Ta, a Co—Cr—Pt—B—Cu, or a Co—Cr—Pt—B—Ag can be used as the material for the sputtering target. For example, in the case of the Co—Cr—Pt alloy, the content of Cr can be made within a range of 10 at % to 27 at %, and the content of Pt can be made within a range of 8 at % to 16 at %. For example, in the case of the Co—Cr—Pt—B—Ta alloy, the content of Cr can be made within a range of 10 at % to 27 at %, the content of Pt can be made within a range of 8 at % to 16 at %, the content of B can be made within a range of 1 at % to 20 at %, and the content of Ta can be made within a range of 1 at % to 4 at %. For example, in the case of the Co—Cr—Pt—B—Cu alloy, the content of Cr can be made within a range of 10 at % to 27 at %, the content of Pt can be made within a range of 8 at % to 16 at %, the content of B can be made within a range of 1 at % to 20 at %, and the content of Cu can be made within a range of 1 at % to 10 at %. In the case of the Co—Cr—Pt—B—Ag alloy, the content of Cr can be made within a range of 10 at % to 27 at %, the content of Pt can be made within a range of 8 at % to 16 at %, the content of B can be made within a range of 1 at % to 20 at %, and the content of Ag can be made within a range of 1 at % to 10 at %.

At this point, it is preferable for the crystal orientation of the Cr or the Cr alloy of the nonmagnetic undercoat layer 4 to be formed such that the preferred orientation plane exhibits the crystal plane of (100).

Following formation of the magnetic layer 5, a protective layer 6, for example a protective layer which has carbon as the principal component, is formed using common methods, for example the sputtering method, the plasma CVD method, or a combination thereof.

Furthermore, a lubricating layer is formed on the protective layer as necessary, by applying a perfluoropolyether fluorine type lubricant by using the dip method or the spin coating method.

Magnetic recording mediums according to the present invention and conventional magnetic recording mediums were produced under the respective conditions of the examples and the comparative examples shown below. Thereafter, a glide test was performed using a glide tester, with a glide height of 0.4 μinches, which was the test condition, and each of the characteristic tests were performed on the accepted magnetic recording mediums.

[Characteristic Test Items]

The record reproduction performance of the magnetic recording medium samples accepted by the abovementioned glide test was examined using a read/write analyzer (GUZI Co. (US) made: RWA 1632).

For the record reproduction performance, electromagnetic transfer characteristics such as the reproduction signal output (TAA), the half-width (PW50) of the solitary wave reproduction output, the SNR, and the overwrite (OW) were measured.

For the evaluation of the record reproduction performance, a complex type thin-film magnetic recording head, which had a giant magnetic resistance (GMR) element in its reproduction section, was used.

The measurement of noise was measured by the integral noise from 1 MHz to 375 kFCI equivalent frequency when a 500 kFCI pattern signal was written. The reproduction output was measured at 250 kFCI, and was calculated by SNR=20×log (reproduction output/integral noise from 1 MHz to 375 kFCI equivalent frequency).

For the measurement of the retentivity (Hc) and the squareness ratio (S*), an electro-optical Kerr effect type magnetic property measurement device (made by Hitachi Electrical Engineering Co. (Japan): R01900) was used. For the measurement of the magnetic anisotropic index (OR) and the magnetic anisotropic index (MrtOR) of the residual magnetization amount, a VSM (made by Riken Electrical Co. (Japan): BHV-35) was used.

### EXAMPLE 1

A nonmagnetic substrate 1, where an NiP film (thickness 12 μm) was formed by electroless deposition on the surface of a substrate comprising Al (outside diameter 95 mm, inside diameter 25 mm, thickness 1.270 mm), and the surface average roughness Ra was made to be 0.5 nm by performing texture processing on the surface thereof, was produced.

This nonmagnetic substrate 1 was accommodated in the chamber interior of a DC magnetron sputter device (Aneruva Corp.: C3010), and this chamber interior was evacuated until the vacuum attainment level became 2×10⁻⁷ Torr (2.7×10⁻⁵ Pa).

Following formation of the orientation control layer (thickness 1 nm) comprising a CoW alloy (Co: 50 at %, W: 50 at %) on this nonmagnetic substrate, it was heated to 250° C.

Next, the surface of the orientation control layer was exposed to oxygen gas. The pressure of the oxygen gas was made to be 0.05 Pa, and the processing time was made to be 5 seconds.

The nonmagnetic undercoat layer was formed on this nonmagnetic substrate. The nonmagnetic undercoat layer was made to be a multi-layered structure having a second layer (thickness 3 nm) comprising a CrMoB alloy (Cr: 80 at %, Mo: 20 at %, B: 5 at %) on a first configuration layer (thickness 2 nm) comprising a CrMn alloy (Cr: 80 at %, Mn: 20 at %).

Next, the nonmagnetic middle layer (thickness 3 nm) comprising a CoCrZr alloy (Co: 70 at %, Cr: 23 at %, Zr: 7 at %) was formed.

Next, the magnetic layer was installed. As the magnetic layer, a first configuration layer (thickness 10 nm) comprising a CoCrPtB alloy (Co: 60 at %, Cr: 25 at %, Pt: 14 at %, B: 6 at %) was formed. In addition, directly thereon, a second configuration layer (thickness 10 nm) comprising a CoCrPtB alloy (Co: 60 at %, Cr: 10 at %, Pt: 15 at %, B: 15 at %) was formed.

When forming each of the abovementioned layers, Ar was used as the sputter gas, and the pressure thereof was made to be 6 mTorr (0.8 Pa). Next, a protective layer (thickness 3 nm) comprising carbon was formed by CVD. Next, a lubricating layer (thickness 2 nm) was formed by spreading a lubricant comprising perfluoropolyether on the surface of the protective layer, and the magnetic recording medium according to the present invention was obtained.

### EXAMPLES 2 To 32

Except for the point of making the alloy composition and the film thickness of the orientation control layer the values shown in Table 1, the same processes as Example 1 were performed to obtain the magnetic recording medium according to the present invention.

### EXAMPLE 34

A stabilizing layer and a ferromagnetic bonding layer were installed instead of a nonmagnetic middle layer. For the stabilizing layer, a target comprising CoCrZr (Co: 79 at %, Cr: 18 at %, Zr: 3%) was used to laminate 2 nm. For the nonmagnetic bonding layer, a target comprising Ru was used to laminate 0.8 nm. Other than this, the same processes as Example 1 were performed to obtain the magnetic recording medium according to the present invention.

### COMPARATIVE EXAMPLE 1

Except for the point of not providing an orientation control layer, the same processes as Example 1 were performed to obtain a conventional magnetic recording medium.

### COMPARATIVE EXAMPLE 2

Except for the point of not providing an orientation control layer, the same processes as Example 34 were performed to obtain a conventional magnetic recording medium.

### COMPARATIVE EXAMPLES 3 TO 6

Except for the point of making the film thickness of the orientation control layer the values shown in Table 1, the same processes as Example 1 were performed to obtain a conventional magnetic recording medium.

### COMPARATIVE EXAMPLES 7 TO 8

Except for the point of making the line density of the striations from texture processing the values shown in Table 1, the same processes as Example 1 were performed to obtain a conventional magnetic recording medium.

The characteristic test results of the magnetic recording mediums of the Examples and Comparative Examples are shown in Table 1.

TABLE 1

| | | Orientation | | | | | | | | | |
|---|---|---|---|---|---|---|---|---|---|---|---|
| | | control | | | | | | | | | |
| | Orientation | layer film | Line | | Square- | | | | | | |
| | control layer alloy | thickness | density | Retentivity | ness | | | TAA | OW | PW50 | SNR |
| | composition | nm | lines/mm | Oe | ratio | OR | MrtOR | (μV) | (dB) | (ns) | (dB) |
| Example 1 | 50Co—50W | 0.1 | 25000 | 4231 | 0.81 | 1.06 | 2.01 | 1389 | 38.9 | 6.31 | 19.7 |
| Example 2 | 50Co—50W | 0.5 | 25000 | 4321 | 0.82 | 1.07 | 2.11 | 1421 | 38.1 | 6.25 | 20.4 |
| Example 3 | 50Co—50W | 1 | 25000 | 4429 | 0.83 | 1.08 | 2.22 | 1442 | 37.9 | 6.21 | 20.8 |
| Example 4 | 50Co—50W | 2 | 25000 | 4439 | 0.83 | 1.08 | 2.21 | 1431 | 37.6 | 6.21 | 20.6 |
| Example 5 | 50Co—50W | 5 | 25000 | 4511 | 0.83 | 1.08 | 2.19 | 1442 | 37.5 | 6.22 | 20.3 |
| Example 6 | 50Co—50W | 4.5 | 25000 | 4473 | 0.83 | 1.08 | 2.19 | 1433 | 37.8 | 6.22 | 20.4 |
| Example 7 | 60Co—40W | 1 | 25000 | 4454 | 0.82 | 1.08 | 2.11 | 1422 | 37.8 | 6.24 | 20.2 |
| Example 8 | 25Co—75W | 1 | 25000 | 4451 | 0.82 | 1.07 | 2.15 | 1431 | 37.9 | 6.26 | 20.5 |
| Example 9 | 60Co—40Mo | 1 | 25000 | 4423 | 0.81 | 1.08 | 2.19 | 1411 | 38.1 | 6.26 | 20.3 |
| Example 10 | 45Co—55Mo | 1 | 25000 | 4416 | 0.82 | 1.07 | 2.18 | 1432 | 38.3 | 6.24 | 20.2 |
| Example 11 | 25Co—75Mo | 1 | 25000 | 4491 | 0.82 | 1.08 | 2.11 | 1436 | 37.6 | 6.24 | 20.1 |
| Example 12 | 55Co—45Ta | 1 | 25000 | 4475 | 0.81 | 1.08 | 2.17 | 1428 | 37.6 | 6.23 | 20.1 |
| Example 13 | 40Co—60Ta | 1 | 25000 | 4451 | 0.82 | 1.08 | 2.15 | 1436 | 37.9 | 6.24 | 20.2 |
| Example 14 | 55Co—45Nb | 1 | 25000 | 4481 | 0.82 | 1.08 | 2.19 | 1427 | 38.2 | 6.22 | 20.4 |
| Example 15 | 40Co—60Nb | 1 | 25000 | 4451 | 0.82 | 1.07 | 2.1 | 1421 | 38.5 | 6.22 | 20.3 |
| Example 16 | 25Co—75Nb | 1 | 25000 | 4475 | 0.81 | 1.08 | 2.18 | 1435 | 38.1 | 6.25 | 20.3 |
| Example 17 | 55Ni—45Ta | 1 | 25000 | 4439 | 0.82 | 1.08 | 2.21 | 1427 | 37.7 | 6.24 | 20.4 |
| Example 18 | 40Ni—60Ta | 1 | 25000 | 4439 | 0.82 | 1.07 | 2.18 | 1431 | 38.1 | 6.23 | 20.4 |
| Example 19 | 60Ni—40Nb | 1 | 25000 | 4419 | 0.82 | 1.08 | 2.18 | 1436 | 37.6 | 6.23 | 20.4 |
| Example 20 | 45Co—55Nb | 1 | 25000 | 4418 | 0.81 | 1.07 | 2.16 | 1425 | 37.5 | 6.22 | 20.2 |
| Example 21 | 25Co—75Nb | 1 | 25000 | 4475 | 0.82 | 1.08 | 2.13 | 1422 | 38 | 6.24 | 20.1 |
| Example 22 | 55Fe—45W | 1 | 25000 | 4436 | 0.82 | 1.08 | 2.16 | 1426 | 38.1 | 6.22 | 20.4 |
| Example 23 | 40Fe—60W | 1 | 25000 | 4418 | 0.81 | 1.08 | 2.18 | 1426 | 37.6 | 6.23 | 20.3 |
| Example 24 | 25Fe—75W | 1 | 25000 | 4445 | 0.82 | 1.08 | 2.16 | 1427 | 37.9 | 6.22 | 20.4 |
| Example 25 | 55Fe—45Mo | 1 | 25000 | 4417 | 0.82 | 1.07 | 2.18 | 1428 | 38.2 | 6.22 | 20.1 |
| Example 26 | 40Fe—60Mo | 1 | 25000 | 4437 | 0.81 | 1.08 | 2.11 | 1431 | 38.4 | 6.25 | 20.2 |
| Example 27 | 25Fe—75Mo | 1 | 25000 | 4411 | 0.82 | 1.07 | 2.17 | 1433 | 37.8 | 6.24 | 20.3 |
| Example 28 | 55Fe—45Nb | 1 | 25000 | 4398 | 0.82 | 1.08 | 2.14 | 1441 | 38.4 | 6.23 | 20.3 |
| Example 29 | 40Fe—60Nb | 1 | 25000 | 4378 | 0.81 | 1.08 | 2.18 | 1427 | 37.8 | 6.22 | 20.1 |
| Example 30 | 25Fe—75Nb | 1 | 25000 | 4398 | 0.82 | 1.08 | 2.11 | 1442 | 38.5 | 6.22 | 20.1 |
| Example 31 | 45Co—25W—20Mo | 1 | 25000 | 4414 | 0.81 | 1.08 | 2.18 | 1421 | 37.4 | 6.25 | 20.2 |
| Example 32 | 45Co—25W—20Ta | 1 | 25000 | 4415 | 0.82 | 1.07 | 2.18 | 1428 | 37.9 | 6.23 | 20.1 |
| Example 33 | 25Co—20Ni—55W | 1 | 25000 | 4419 | 0.81 | 1.08 | 2.14 | 1429 | 38.1 | 6.24 | 20.4 |
| Example 34 | 50Co—50W | 1 | 25000 | 4578 | 0.82 | 1.08 | 2.22 | 1427 | 38.2 | 6.18 | 20.9 |
| Comp example 1 | none | | 25000 | 4211 | 0.8 | 1.05 | 1.89 | 1357 | 39.7 | 6.32 | 19.2 |
| Comp example 2 | none | | 25000 | 4325 | 0.81 | 1.05 | 1.92 | 1345 | 39.4 | 6.28 | 19.5 |
| Comp example 3 | 50Co—50W | 0.05 | 25000 | 4221 | 0.8 | 1.05 | 1.9 | 1367 | 39.5 | 6.3 | 19.4 |
| Comp example 4 | 50Co—50W | 6 | 25000 | 4555 | 0.83 | 1.08 | 2.19 | 1433 | 37.5 | 6.23 | 20 |
| Comp example 5 | 50Co—50W | 10 | 25000 | 4624 | 0.83 | 1.08 | 2.18 | 1422 | 36.9 | 6.24 | 19.7 |
| Comp example 6 | 50Co—50W | 20 | 25000 | 4712 | 0.83 | 1.08 | 2.17 | 1437 | 36.5 | 6.23 | 19 |
| Comp example 7 | 50Co—50W | 1 | 6000 | 4334 | 0.82 | 1.03 | 1.63 | 1243 | 40.5 | 6.43 | 17.8 |
| Comp example 8 | 50Co—50W | 1 | 210000 | 4345 | 0.8 | 1 | 1 | 1012 | 43.2 | 6.67 | 15.8 |

In Examples 1 to 6, the thickness of the orientation control layer Co—W type alloy (Co: 50 at %, W: 50 at %) is being varied.

There is a peak in the SNR with respect to the film thickness, and it can be understood that in the range of 10 to 20 angstroms, it is particularly excellent.

However, as is shown in Comparative Examples 4 and 5, even if it is in the range of 1 to 100 angstroms, compared to Comparative Example 1 where an orientation control layer has not been formed, the magnetic anisotropy is superior, and it can be understood that as a result, the SNR is superior.

As is shown in Comparative Example 3, when the film thickness of the orientation control layer is less than 1 angstrom (in the present example, it is 0.5 angstroms), the TAA decreases, and it is inferior from the point of electromagnetic transfer characteristics.

Furthermore, as is shown in Comparative Example 6, when the film thickness of the orientation control layer is 200 nm, even though the magnetic anisotropy is superior, crystal grain coarsening occurs, which decreases the SNR.

Furthermore, as is shown in Example 3 and Comparative Examples 7 to 34, in a magnetic recording medium according to the present invention, even in a case where the film thickness of the orientation control layer is 1 nm and is formed very thinly, it is clear that it is exhibiting a large effect in improving the magnetic anisotropy.

In a case where the film thickness of the orientation control layer is 1 nm and is formed very thinly, there is an ununiformity which remains in the film quality, and it can be thought that this is because the refinement of the particle size is contributing. When the particle size of the orientation control layer becomes refined, because the magnetic anisotropy also improves, the magnetic recording characteristics of the magnetic recording medium can be improved.

In Examples 7 to 30, the alloy composition of the orientation control layer is being varied.

It can be understood that by using a Co—W type alloy, a Co—Mo type alloy, a Co—Ta type alloy, a Co—Nb type alloy, a Ni—Ta type alloy, a Ni—Nb type alloy, a Fe—W type alloy, a Fe—Mo type alloy, or a Fe—Nb type alloy for the orientation control layer, a favorable magnetic anisotropy in the circumferential direction can be obtained, and it is clear that the recording and reproducing characteristics become superior.

In Examples 31 to 33, a three-element type alloy is used for the orientation control layer.

It can be understood that by using a Co—W—Mo type alloy, a Co—W—Ta type alloy, or a Co—Ni—W type alloy for the orientation control layer, a favorable magnetic anisotropy in the circumferential direction can be obtained, and it is clear that the recording and reproducing characteristics become superior.

As can be understood from the comparison between Example 34 and Comparative Example 2, it is clear that in an AFC medium, the expression of the effects of the magnetic anisotropy due to the orientation control layer can be seen, and the recording and reproducing characteristics become superior.

Furthermore, as can be understood from the comparison between the Examples and Comparative Examples 7 and 8, by making the line density of the striations 7500 (lines/mm) or more, and more preferably 20,000 (lines/mm) or more and less than 200,000 (lines/mm), it is clear that a favorable magnetic anisotropy can be obtained.

1. A magnetic recording medium comprising at least an orientation control layer, a nonmagnetic undercoat layer, a magnetic layer, and a protective layer in this order on an aluminum substrate which has striations on the surface and is plated with NiP or a NiP alloy,
wherein said orientation control layer comprises any one or more components selected from the group consisting of Co, Ni, and Fe, and any one or more components selected from the group consisting of W, Mo, Ta and Nb.

2. A magnetic recording medium according to claim 1, wherein said orientation control layer contains at least one alloy selected from the group consisting of alloys in the systems of Co—W, Co—Mo, Co—Ta, Co—Nb, Ni—Ta, Ni—Nb, Fe—W, a Fe—Mo, and a Fe—Nb.

3. A magnetic recording medium according to claim 1, wherein said aluminum substrate is a substrate in which a Ni—P type alloy film is formed by electroless deposition on an Al—Mg alloy substrate body.

4. A magnetic recording medium according to claim 1, wherein a film thickness of said orientation control layer is within a range of 1 angstrom to 50 angstroms.

5. A magnetic recording medium according to claim 1, wherein a line density of said striations is 7500 (lines/mm) or more.

6. A magnetic recording medium according to claim 1, wherein a magnetic isotropic index of said magnetic layer (retentivity in the circumferential direction/retentivity in the radial direction), is 1.05 or more.

7. A magnetic recording medium according to claim 1, wherein a magnetic anisotropic index of said residual magnetization amount (residual magnetization amount in the circumferential direction/residual magnetization amount in the radial direction), is 1.05 or more.

8. A magnetic recording medium according to claim 1, wherein said nonmagnetic undercoat layer contains a Cr layer, or a Cr alloy layer containing one or more components selected from among Ti, Mo, Al, Ta, W, Ni, B, Si, V, and Mn.

9. A magnetic recording medium according to claim 1, wherein said magnetic layer contains any one or more components selected from the group consisting of alloys in the systems of Co—Cr—Pt, Co—Cr—Pt—Ta, Co—Cr—Pt—B, and Co—Cr—Pt—B—Y (Y represents Ta or Cu).

10. A magnetic recording and reproducing apparatus characterized in comprising a magnetic recording medium according to claim 1, and a magnetic head which records and reproduces information on the magnetic recording medium.
